(19) United States
(12) Patent Application Publication
(10) Pub. No.: US 2009/0252549 A1
(43) Pub. Date: Oct. 8, 2009

(54) Spline Connection Structure

(75) Inventors: Yoshinori Takeuchi, Tsuchiura-shi (JP); Naoyuki Okuno, Tsuchiura-shi (JP); Tetsuya Sakairi, Tsuchiura-shi (JP); Youichi Iltsuka, Tsuchiura-shi (JP)

Correspondence Address: CROWELL & MORING LLP;INTELLECTUAL PROPERTY GROUP, P.O. BOX 14300, WASHINGTON, DC, 20044-4300, US

(73) Assignee: Hitachi Construction Machinery Co., Ltd., Tokyo (JP)

(21) Appl. No.: 12/418,859

(22) Filed: Apr. 6, 2009

(30) Foreign Application Priority Data
Apr. 7, 2008 (JP) 2008-99435

(51) Int. Cl. F16B 7/04

(52) U.S. Cl. 403/298

(57) ABSTRACT

A spline connection structure is provided with a shaft spline and a bore spline. The shaft spline is comprised of plural involute teeth formed on a shaft, while the bore spline is comprised of plural involute teeth formed on a hub and maintained in engagement with the teeth of the shaft spline. The hub is provided with at least one cylindrical hole and a thin wall portion facing a lower end portion of the cylindrical hole. The thin wall portion is pressed by a pressing member inserted in the cylindrical hole to widen an interval between at least two of the teeth of the bore spline, said at least two teeth being located in a vicinity of the thin wall portion, such that at least one of the at least two teeth is pressed against at least one associated tooth of the teeth of the shaft spline and is restrained to restrict movement of the hub relative to the shaft. At least one tooth of at least one of the shaft spline and bore spline, said at least one tooth being located in a vicinity of the thin wall portion, is provided with a cutout portion formed by cutting off the at least one tooth at a part thereof such that the cutout portion is located in a neighborhood of an end face of the hub located on a side opposite another end face of the hub located on a side of an end portion of the shaft.

### CROSS-REFERENCE TO RELATED APPLICATION

This application claims the priority of Japanese Patent Application 2008-099435 filed Apr. 7, 2008, which is incorporated herein by reference.

### BACKGROUND OF THE INVENTION

1. Field of the Invention

This invention relates to a spline connection structure capable of reducing stress concentration that occurs at the base of each of teeth, which form a spline, upon transmission of rotational force between a shaft and a hub.

2. Description of the Related Art

A variety of apparatus are provided with a spline connection structure in which a shaft spline comprised of plural teeth formed on an outer circumference of a shaft and a bore spline comprised of plural teeth formed on an inner circumference of a hub are maintained in engagement with each other to permit transmission of rotational force. Various inventions have conventionally been made to provide such spline connection structures with improved fatigue strength.

According to the invention disclosed in JP-A-58-077913, for example, elevated profile portions of splines on a torque transmitting side are set irregular to reduce stress concentration upon transmission of a torque. According to the invention disclosed in JP-A-10-002322, on the other hand, teeth are formed in a circular arc profile in place of an involute profile, whereby stress concentration that occurs in the lower corner portions of the teeth, in other words, at the bases of the teeth is reduced to achieve an improvement in fatigue strength.

In the invention disclosed in JP-A-58-077913, however, the elevated profile portions of the splines are formed irregular, and therefore, a special cutting tool is needed such as, for example, designing the cutting edges of a hob as a cutting tool in a special shape. The invention disclosed in JP-A-58-077913 is, therefore, accompanied by a problem in that the machining cost becomes high. The invention disclosed in JP-A-10-002322 also needs a special cutting tool to machine teeth in a circular arc profile, and therefore, involves a problem in that it does not have general versatility.

Because of these various problems, a shaft spline and bore spline are generally formed as involute splines. To restrict movement of a hub relative to a shaft, a thin wall portion of the hub, said thin wall portion facing a lower end portion of a cylindrical hole formed in the hub, is pressed by a pressing member, for example, a clamping screw inserted in the cylindrical hole. An interval between at least two of the teeth of the bore spline, said at least two teeth of the bore spline being located in a vicinity of the thin wall portion to which pressing force has been applied by the clamping screw as described above, is widened such that at least one of the at least two teeth of the bore spline is pressed against at least one associated tooth of the teeth of the shaft spline and is restrained to restrict movement of the hub relative to the shaft.

The problem of fatigue due to stress concentration, however, still remains unsolved even in the case of a conventional spline connection structure in which as mentioned above, a shaft spline and bore spline are formed as involute splines having general versatility and movement of a hub relative to a shaft is restricted by pressing a thin wall portion, which is formed in the hub, with a pressing member such as a clamping screw and restraining at least one tooth of the bore spline.

Described specifically, upon transmission of rotational force between a shaft and a hub, off-centering between the shaft and the hub due to an assembly error and a bending moment due to a relative inclination between the shaft and the hub take place in addition to torsional stress by a torque, so that stress concentrates around an end face of the bore spline. The expression “around an end face of the bore spline” in this case means “around an end face of the hub that is located on a side opposite an end face of the hub that is in turn located on a side of an end portion of the shaft”. When the thin wall portion of the hub is pressed by a pressing member such as the above-mentioned clamping screw and the interval between at least two of the teeth of the bore spline is hence widened to cause deformation between these at least two teeth, the interval of one of the teeth of the shaft spline, said one tooth being associated with at least one of the at least two teeth of the bore spline, and its adjacent tooth is widened to cause deformation of these two teeth of the shaft spline, resulting in the occurrence of stress concentration at bases of these two teeth of the shaft spline. Upon transmission of rotational force, the pressing force from the pressing member, therefore, also causes stress concentration at the bases of portions of the above-mentioned two teeth of the shaft spline. The above-mentioned portions are located in the neighborhood of the end face of the hub that is in turn located on the side opposite the end face of the hub that is in turn located on the side of the above-mentioned end of the shaft.

As combined stress concentration occurs by such torsional stress and bending moment as mentioned above and by the pressing force from the pressing member such as the clamping screw upon transmission of rotational force between the shaft and the hub, it is necessary to surely provide the shaft spline with large strength in view of its fatigue strength in the case of the spline connection structure that is provided with the shaft spline comprised of the conventional involute teeth and the bore spline comprised of the conventional involute teeth and presses the thin wall portion of the hub to widen the interval between at least two teeth of the bore spline, to restrain at least one of the at least two teeth of the bore spline by its associated tooth of the shaft spline and hence to restrict movement of the hub relative to the shaft. With respect to the shaft that constitutes this spline connection structure, there is accordingly no choice other than setting its diametrical dimension large, leading to a problem that induces an increase in the size of an apparatus to be provided with the spline connection structure.

### SUMMARY OF THE INVENTION

With the foregoing circumstances of the related art in view, the present invention has as an object thereof the provision of a spline connection structure that is provided with a shaft spline and bore spline comprised of involute splines, respectively, and can reduce stress concentration.

To achieve the above-described object, the present invention provides, in one aspect thereof, a spline connection structure provided with:

a shaft spline comprised of plural involute teeth formed on an outer circumference of a shaft, and

a bore spline comprised of plural involute teeth formed on an inner circumference of a hub and maintained in engagement with the teeth of the shaft spline, wherein:

the hub is provided with at least one cylindrical hole formed therein and also with a thin wall portion facing a lower end portion of the cylindrical hole, the thin wall portion of the hub is pressed by a pressing member inserted in the cylindrical hole to widen an interval between at least two of the teeth of the bore spline, said at least two teeth of the bore spline being located in a vicinity of the thin wall portion, such that at least one of the at least two teeth of the bore spline is pressed against at least one associated tooth of the teeth of the shaft spline and is restrained to restrict movement of the hub relative to the shaft, and

at least one tooth of at least one of the shaft spline and bore spline, said at least one tooth being located in a vicinity of the thin wall portion facing the lower end portion of the cylindrical hole in the hub, is provided with a cutout portion formed by cutting off the at least one tooth at a part thereof such that the cutout portion is located in a neighborhood of an end face of the hub located on a side opposite another end face of the hub located on a side of an end portion of the shaft.

At the cutout-portion-containing part of the at least one tooth of at least one of the shaft spline and bore spline in the spline connection structure according to the present invention constructed as described above, specifically at opposing parts of the shaft spline and bore spline comprised of the involute splines, respectively, said opposing parts being located in the vicinity of the thin wall portion facing the lower end portion of the cylindrical hole in the hub and in the neighborhood of the end face of the hub that is located on the side opposite the end face of the hub that is in turn located on the side of the end portion of the shaft, no engagement takes place between the part of the tooth of the at least one of the shaft spline and bore splines and a corresponding part of the associated one of the teeth of the other spline owing to the provision of the cutout portion. At the part of the associated tooth of the shaft spline, said part being located at the cutout portion or corresponding to the cutout portion where the cutout portion is formed on the side of the bore spline, no situation hence arises that the part of the associated tooth of the shaft spline would be deformed as a result of the pressing of the corresponding tooth of the bore spline against the associated tooth of the shaft spline. As a consequence, upon transmission of rotational force between the shaft and the hub, stress concentration can be reduced at the tooth part where the cutout portion exists, thereby making it possible to use a shaft spline of smaller strength.

In the spline connection structure according to the present invention, the shaft may preferably have machining relief grooves machined by a pinion cutter.

In the spline connection structure according to the present invention, the shaft spline may preferably have elevated profile portions machined by a hob.

In the spline connection structure according to the present invention, the cylindrical hole may preferably be arranged extending toward a central axis of the shaft.

In the spline connection structure according to the present invention, the hub may preferably be provided with two cylindrical holes formed therein such that the two cylindrical holes are arranged side by side in a longitudinal direction of the shaft, and may preferably be provided with a parallel slot communicating to respective lower ends of the two cylindrical holes and arranged extending in parallel with the longitudinal direction of the shaft.

In the spline connection structure according to the present invention, the cylindrical hole may preferably be provided with an internal thread, and the pressing member may preferably be a clamping screw having an external thread screwed on the internal thread.

In the present invention, at least one tooth of at least one of the shaft spline and bore spline, said at least one tooth being located in the vicinity of the thin wall portion facing the lower end portion of the cylindrical hole in the hub, is provided with the cutout portion formed by cutting off the at least one tooth at the part thereof such that the cutout portion is located in the neighborhood of the end face of the hub located on the side opposite the other end face of the hub located on the side of the end portion of the shaft. In the spline connection structure provided with the shaft spline and bore spline comprised of the involute splines, respectively, it is, therefore, possible to reduce stress concentration at the tooth part where the cutout portion exists. Accordingly, a shaft spline of smaller strength can be used, thereby making it possible to set the diametrical dimension of the shaft spline smaller compared with those of the conventional shaft splines. Owing to this, an apparatus which is to be provided with the spline connection structure can be manufactured in a smaller size.

### BRIEF DESCRIPTION OF THE DRAWINGS

FIG. 1 is a vertical cross-sectional view illustrating a spline connection structure according to a first embodiment of the present invention.

FIGS. 2A to 2C diagrammatically show a shaft which the spline connection structure is provided with, in which FIG. 2A is a side view, FIG. 2B is a perspective view, and FIG. 3 is a fragmentary perspective view illustrating a shaft spline section on an enlarged scale.

FIGS. 3A to 3D diagrammatically show a hub which the spline connection structure is provided with, in which FIG. 3A is a front view, FIG. 3B is a cross-sectional view taken in the direction of arrows IIIB-IIIB of FIG. 3A, FIG. 3C is a perspective view illustrating the hub in a raised position, and FIG. 3D is a perspective view illustrating the hub in a laid position.

FIGS. 4A and 4B diagrammatically depict a spline connection structure according to a second embodiment of the present invention, in which FIG. 4A is a vertical cross-sectional view, and FIG. 4B is an enlarged fragmentary cross-sectional view taken in the direction of arrows IVB-IVB of FIG. 4A.

FIGS. 5A to 5C diagrammatically show a shaft which the spline connection structure of the second embodiment is provided with, in which FIG. 5A is a side view, FIG. 5B is a perspective view, and FIG. 5C is a fragmentary perspective view illustrating a shaft spline section on an enlarged scale.

FIGS. 6A to 6D diagrammatically show a hub which the spline connection structure of the second embodiment is provided with, in which FIG. 6A is a front view, FIG. 6B is a cross-sectional view taken in the direction of arrows VIB-VIB of FIG. 6A, FIG. 6C is a perspective view illustrating the hub in a raised position, and FIG. 6D is a perspective view illustrating the hub in a laid position.

FIG. 7 is a vertical cross-sectional view illustrating a spline connection structure according to a third embodiment of the present invention.

FIGS. 8A to 8C diagrammatically show a hub which the spline connection structure of the third embodiment is provided with, in which FIG. 8A is a vertical cross-sectional view, FIG. 8B is a perspective view illustrating the hub in a raised position, and FIG. 8C is a perspective view illustrating the hub in a laid position.

FIGS. 9A to 9C diagrammatically show a spline connection structure according to a fourth embodiment of the present invention, in which FIG. 9A is a side view, FIG. 9B is a perspective view, and FIG. 9C is a fragmentary perspective view illustrating a shaft spline section on an enlarged scale.

### DETAILED DESCRIPTION OF PREFERRED EMBODIMENTS

Preferred embodiments of the present invention will hereinafter be described with reference to the accompanying drawings.

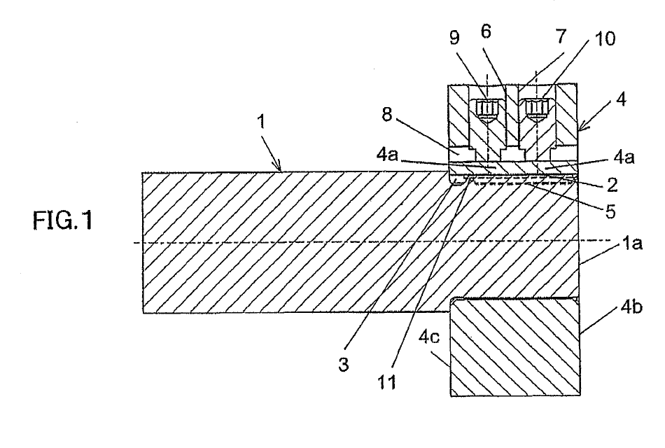

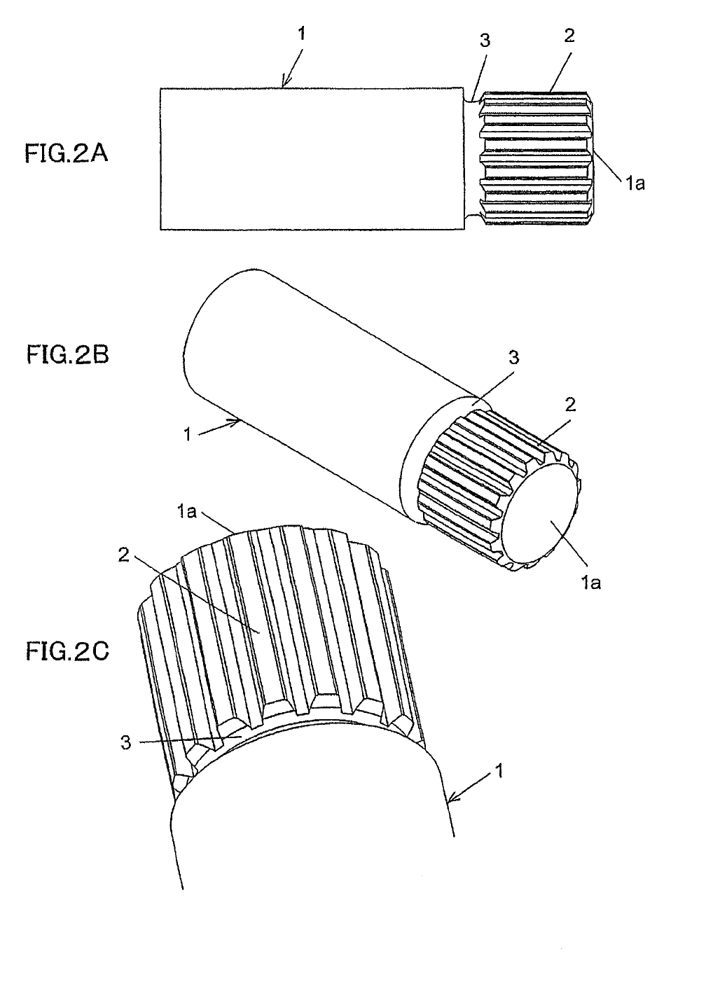

As shown in FIG. 1, a spline connection structure according to a first embodiment of the present invention is constructed of a shaft spline 2 and a bore spline 5 maintained in engagement with each other. The shaft spline 2 is comprised of plural involute teeth formed on an outer circumference of a shaft 1, while the bore spline 5 is comprised of plural involute teeth formed on an inner circumference of a hub 4. As depicted in FIGS. 2A to 2C, the shaft 1 has machining relief grooves 3 machined by a pinion cutter in the neighborhood of an end portion of the shaft spline 2 that is located on a side opposite the side of an end portion 1a.

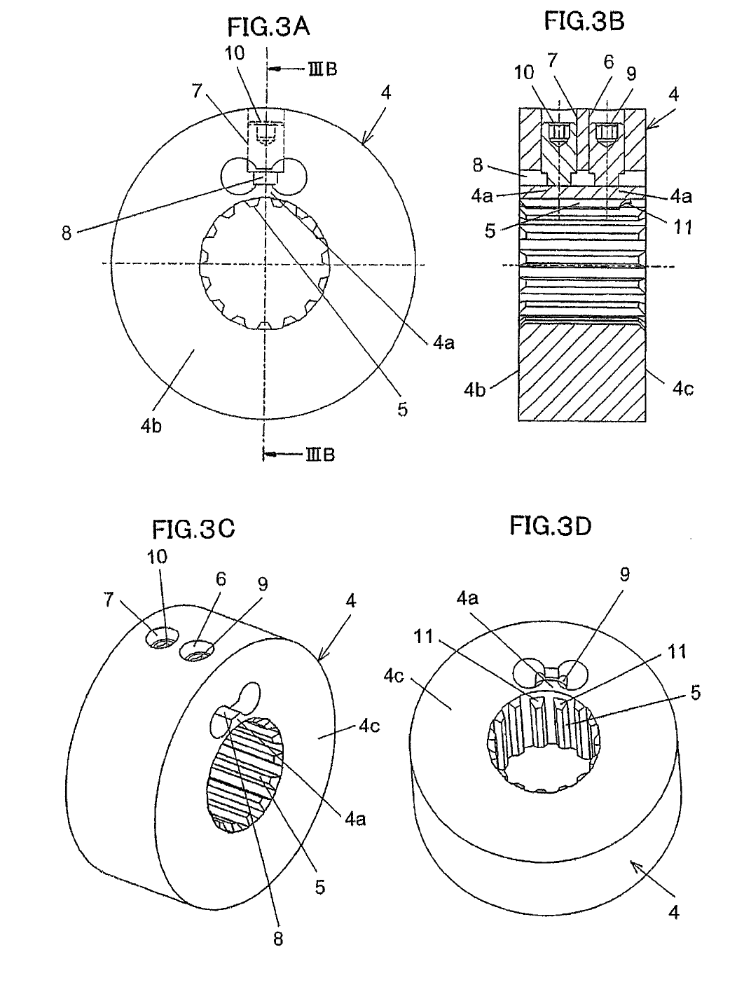

As illustrated in FIG. 3B, etc., the hub 4 has two cylindrical holes arranged extending in a direction toward a central axis of the shaft 1, that is, a first cylindrical hole 6 and second cylindrical hole 7. In these two cylindrical holes 6,7, a first pressing member and second pressing member, for example, a first clamping screw 9 and second clamping screw 10 are inserted such that their external threads are screwed on internal threads formed on circumferences of the cylindrical holes 6,7, respectively. As depicted in FIG. 1, the first cylindrical hole 6 and second cylindrical hole 7 are arranged side by side in the longitudinal direction of the shaft 1, and as also illustrated in FIGS. 3B and 3C, the hub 4 is provided with a parallel slot 8 communicating to respective lower ends of the two cylindrical holes 6,7 and arranged extending in parallel with the longitudinal direction of the shaft 1.

By tightening the first clamping screw 9 and second clamping screw 10 and pressing thin wall portions 4a of the hub 4 that are located facing the lower end portions of the first cylindrical hole 6 and second cylindrical hole 7, respectively, the interval of two teeth of the bore spline 5 that are located in the vicinities of the respective thin wall portions 4a is widened so that at least one of the two teeth of the bore spline 5 is brought into contact with the associated tooth of the shaft spline 2 and is pressed against the associated tooth of the shaft spline 2. As a consequence, the at least one tooth of the bore spline 5 is restrained to restrict movement of the hub 4 relative to the shaft 1.

In this first embodiment, one or more of the teeth of at least one of the shaft spline 2 and bore spline 5, said one or more teeth being located in the vicinities of the above-mentioned respective thin wall portions 4a that are located facing the lower end portions of the two cylindrical holes 6,7 of the hub 4, specifically as shown in FIG. 3D, two teeth of the bore spline 5 are cut off at parts thereof, thereby forming cutout portions 11 in the neighborhood of an end face 4c of the hub 4 that is located on a side opposite an end face 4b of the hub 4 that is in turn located on the side of the end portion 1a of the shaft 1 as shown in FIG. 1.

At the tooth parts where the cutout portions 11 exist in the first embodiment constructed as described above, specifically at opposing parts of the shaft spline 2 and bore spline 5 comprised of the involute teeth, respectively, said opposing parts being located in the vicinities of the thin wall portions 4a facing the respective lower end portions of the two cylindrical holes 6,7 in the hub 4 and in the neighborhood of an end face 4c of the hub 4 that is located on the side opposite to the end face 4b of the hub 4 that is in turn located on the side of the end portion 1a of the shaft 1, no engagement takes place between the parts of the teeth of the shaft spline 2 and the corresponding parts of the associated teeth of the bore spline 5 owing to the provision of the cutout portions 11 as shown in FIG. 1. At the parts of the associated teeth of the shaft spline 2, said parts being located at these cutout portions 11, no situation hence arises that the parts of the associated teeth of the shaft spline 2 would be deformed as a result of the pressing by the corresponding teeth of the bore spline 5. As a consequence, upon transmission of rotational force between the shaft 1 and the hub 4, stress concentration can be reduced at the tooth parts where the cutout portions 11 exist. The present inventors have confirmed by a performance test that compared with a case in which the cutout portions 11 were not provided, the first embodiment provided with the cutout portions 11 was able to reduce stress concentration to ⅕ or smaller at the tooth parts where the cutout portions 11 are included.

According to the first embodiment, stress concentration can be reduced at the tooth parts where the cutout portions 11 exist in the spline connection structure provided with the shaft spline 2 and bore spline 5 comprised of the plural involute teeth, respectively, as mentioned above. Accordingly, no large strength is required for the shaft spline 2, thereby making it possible to set the diametrical dimension of the shaft 1 smaller. Owing to this, an apparatus which is to be provided with the spline connection structure can be manufactured in a smaller size.

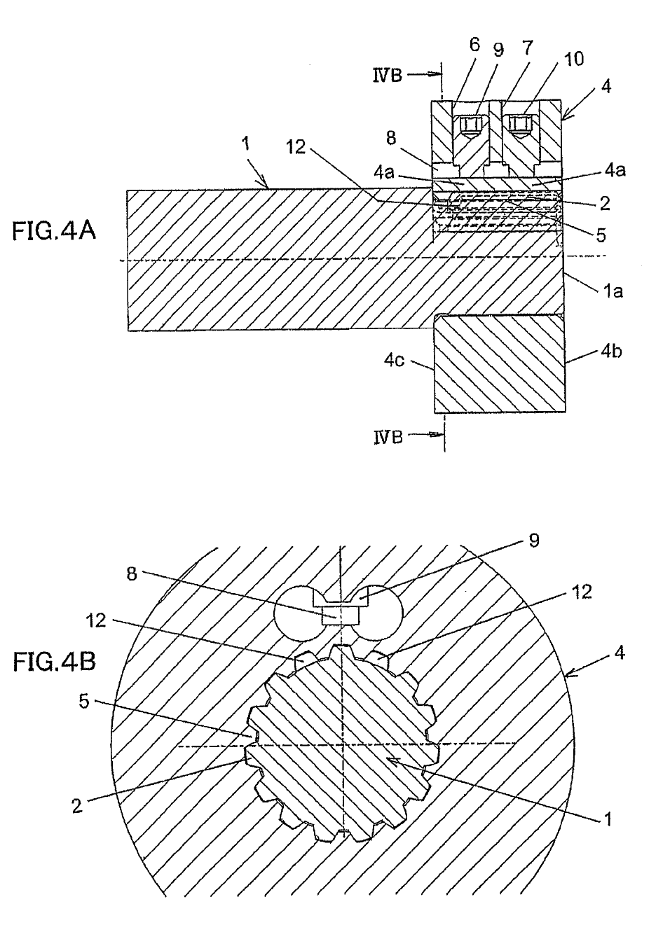

With reference to FIGS. 4A through 6D, a description will next be made of a spline connection structure according to a second embodiment of the present invention.

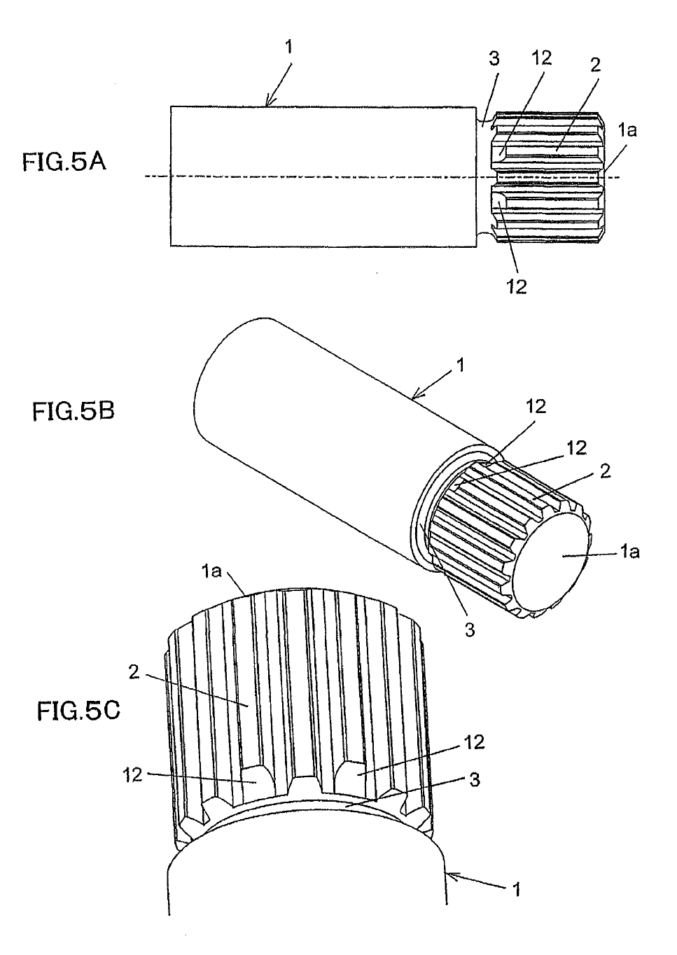

In the spline connection structure of the second embodiment illustrated in FIGS. 4A and 4B, the bore spline 5 of the hub 4 is not provided with any cutoff portion, but as shown in FIG. 4A and FIGS. 5A to 5C, two teeth of the shaft spline 2 that are located in the vicinities of the thin wall portions 4a facing the respective lower end portions of the two cylindrical holes 6,7 in the hub 4 are cut off at parts thereof, thereby forming cutout portions 12 in the neighborhood of the end face 4c of the hub 4 that is located on the side opposite the end face 4b of the hub 4 that is in turn located on the side of the end portion 1a of the shaft 1 as shown in FIG. 4A. These cutout portions 12 can be those machined, for example, by a ball end mill. The rest of the construction is similar to that of the above-described first embodiment.

At opposing parts of the shaft spline 2 and bore spline 5 comprised of the involute teeth, respectively, in the second embodiment constructed as described above, said opposing parts being located in the vicinities of the thin wall portions 4a facing the respective lower end portions of the two cylindrical holes 6,7 in the hub 4 and in the neighborhood of the end face 4c of the hub 4 that is located on the side opposite the end face 4b of the hub 4 that is in turn located on the side of the end portion 1a of the shaft 1, no engagement takes place either as in the first embodiment between the teeth of the shaft spline 2 and those of the bore spline 5 owing to the provision of the cutout portions 12 as shown in FIGS. 4A and 4B. Stress concentration can, therefore, be reduced at the tooth parts where these cutout portions 12 exist. The second embodiment can, accordingly, bring about similar advantageous effects as the first embodiment.

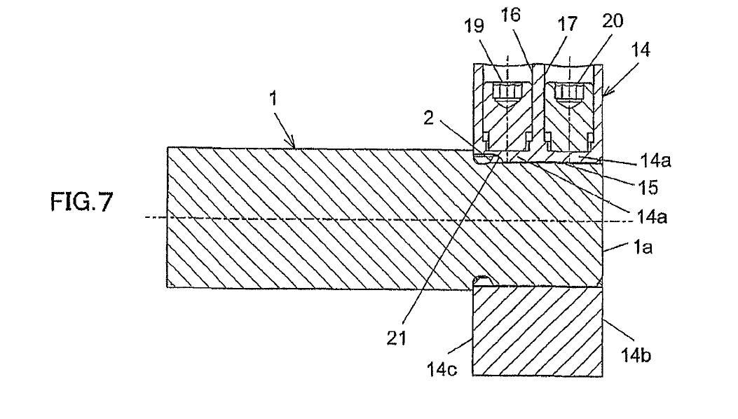

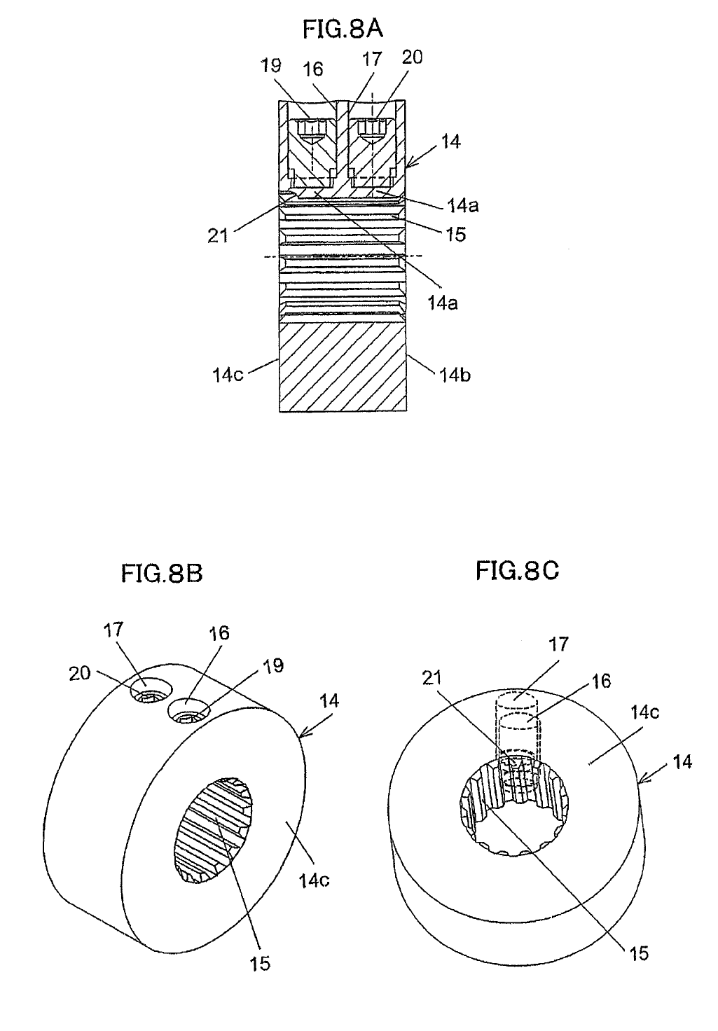

Referring next to FIGS. 7 through 8C, a description will be made of a spline connection structure according to a third embodiment of the present invention.

The spline connection structure according to the third embodiment illustrated in FIG. 7 is characterized by a hub 14. The shaft 1 maintained in engagement with the hub 14 is the same as that in the above-described first embodiment.

The hub 14 in the third embodiment also has two cylindrical holes, that is, a first cylindrical hole 16 and second cylindrical hole 17 arranged extending in the direction toward the central axis of the shaft 1. In these two cylindrical holes 16,17, a first pressing member and second pressing member, specifically, a first clamping screw 19 and second clamping screw 20 are inserted such that their external threads are screwed on internal threads formed on circumferences of the cylindrical holes 16,17, respectively. As depicted in FIG. 7, the first cylindrical hole 16 and second cylindrical hole 17 are arranged side by side in the longitudinal direction of the shaft 1. This third embodiment is, however, not provided with such a parallel slot as that arranged in the first embodiment.

By tightening the first clamping screw 19 and second clamping screw 20 and pressing thin wall portions 14a of the hub 14 that are located facing the lower end portions of the first cylindrical hole 16 and second cylindrical hole 17, respectively, as in the first embodiment, the interval of two teeth of the bore spline 15 that are located in the vicinities of the respective thin wall portions 14a is also widened in this third embodiment so that at least one of the two teeth of the bore spline 15 is brought into contact with the associated tooth of the shaft spline 2 and is pressed against the associated tooth of the shaft spline 2. As a consequence, the at least one tooth of the bore spline 15 is restrained to restrict movement of the hub 14 relative to the shaft 1.

In this third embodiment, one of the teeth of the bore spline 15, said one tooth being located in the vicinity of one of the thin wall portions 14a that are located facing the respective lower end portions of the two cylindrical holes 16,17 of the hub 14, is cut off at a part thereof, thereby forming a cutout portion 21 in the neighborhood of an end face 14c of the hub 14 that is located on a side opposite an end face 14b of the hub 14 that is in turn located on the side of the end portion 1a of the shaft 1 as shown in FIG. 7, that is, the cutout portion 21 shown in FIG. 7 and FIGS. 8A and 8C.

In the third embodiment constructed as described above, no engagement takes place either at the cutout portion 21 between the tooth part of the shaft spline 2 and its associated tooth part of the bore spline 15 owing to the provision of the cutout portion 21 as in the first embodiment. Upon transmission of rotational force between the shaft 1 and the hub 14, stress concentration can hence be reduced at the tooth portion where the cutout portion 21 exists although the spline connection structure of the third embodiment becomes a little greater than that of the first embodiment to an extent corresponding to the provision of the fewer cutout portion. The third embodiment can, therefore, bring about similar advantageous effects as the first embodiment.

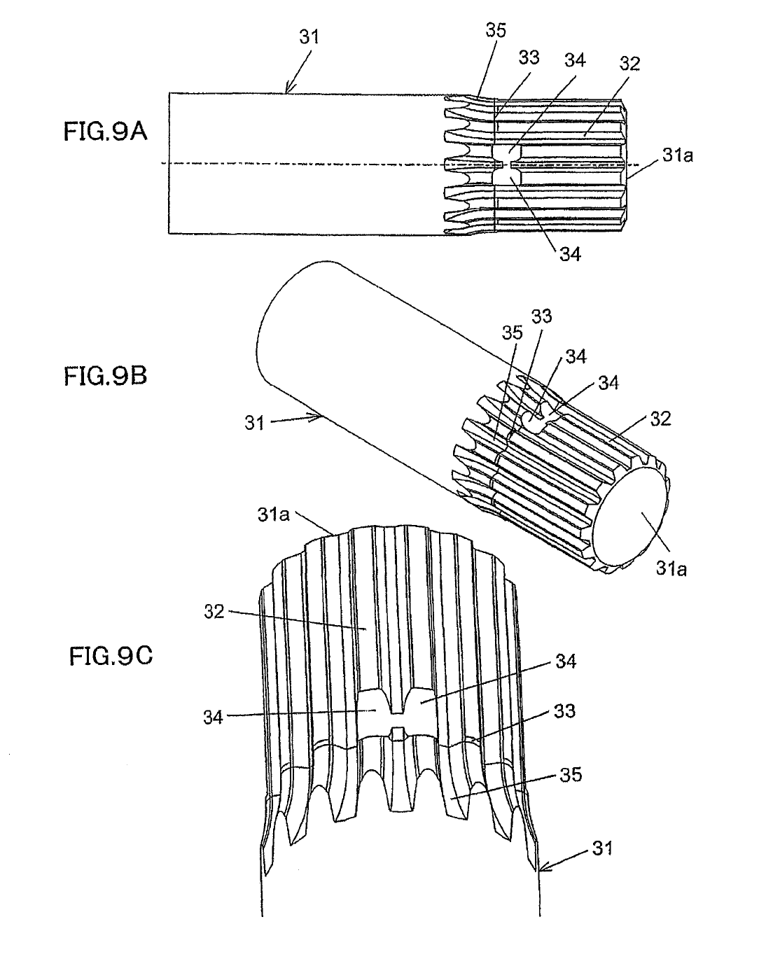

With reference to FIGS. 9A to 9C, a description will hereinafter be made of a spline connection structure according to a fourth embodiment of the present invention, specifically, a shaft which the spline connection structure is provided with.

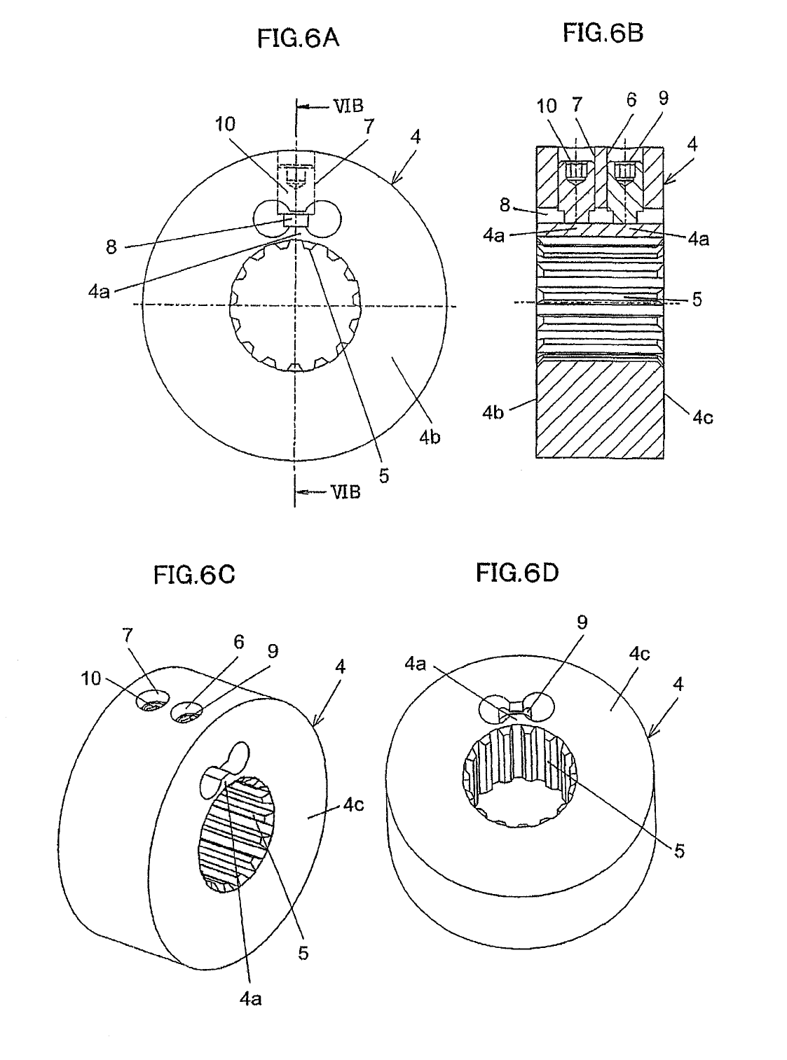

A shaft 31 shown in FIGS. 9A to 9C, which the fourth embodiment is provided with, has elevated profile portions 35 formed by machining a shaft spline 32 with a hob, and is provided with cutoff portions 34 machined, for example, by a ball end mill. A hub that is brought into engagement with the shaft 31 can be, for example, the above-described hub 4 arranged in the second embodiment and shown in FIGS. 6A through 6D. The bore spline 5 of the hub 4 as depicted in FIG. 6A through 6D engages the shaft spline 32 of the shaft 31 as illustrated in FIGS. 9A to 9C and, at a position where the end face 4c of the hub 4 is brought into registration with a connection line 33 of the shaft 31, the hub 4 is restricted in movement relative to the shaft 31 owing to the above-mentioned tightening of the first clamping screw 9 and second clamping screw 10.

In the fourth embodiment constructed as described above, no engagement takes place either between the tooth parts of the shaft spline 32, said tooth parts being located at the cutout portions 34, and their associated tooth parts of the bore spline 5 as in the second embodiment depicted in FIGS. 4A through 6D owing to the provision of the cutout portion 34 formed on the shaft spline 32 of the shaft 31. As a consequence, upon transmission of rotational force between the shaft 31 and the hub 4, stress concentration can be reduced at the tooth parts where the cutout portions 34 exist. The fourth embodiment can, accordingly, bring about similar advantageous effects as the second embodiment.

It is to be noted that, although the cutout portion(s) 11, 12, 21 or 34 is(are) formed on only one of the shaft and hub in each of the above-described embodiments, similar cutout portion(s) may be arranged on both the shaft and the hub.

In each of the above-described embodiments, the first clamping screw 9 or 19 and the second clamping screw 10 or 20 are arranged as pressing members for pressing the thin wall portions 4a or 14a of the hub 4 or 14. The present invention is, however, not limited to such constructions. As the pressing members, pins such as, for example, tapered pins may be arranged. Concerning the combination of a pressing member such as a clamping screw and a cylindrical hole in which the pressing member is inserted, the present invention is not limited to the arrangement of two of such combinations as in each of the above-described embodiments but may include the arrangement of one of such a combination or three or more of such combinations.

In each of the above-described embodiments, one or two cutout portion(s) 11, 12, 21 or 34 are arranged. Such cut out portion(s) 11, 12, 21 or 34 may, however, be arranged as many as 3 or more. When forming the cutout portion(s) 11, 12, 21 or 34, they may be formed such that the lowest position(s) of the cutout portion(s) 11, 12, 21 or 34, specifically, its(their) position(s) closest to the central axis of the shaft when the cutout portion(s) is(are) formed on the shaft spline or its (their) position(s) closest to the inner circumference of the hub when the cutout portion(s) is(are) formed on the bore spline coincide(s) with, become(s) slightly higher than or become(s) slightly lower than the height position(s) of the base(s) of the adjacent tooth(teeth) in which no cutout portion is formed.

1. A spline connection structure provided with:
a shaft spline comprised of plural involute teeth formed on an outer circumference of a shaft, and
a bore spline comprised of plural involute teeth formed on an inner circumference of a hub and maintained in engagement with said teeth of said shaft spline, wherein:
said hub is provided with at least one cylindrical hole formed therein and also with a thin wall portion facing a lower end portion of said cylindrical hole, said thin wall portion of said hub is pressed by a pressing member inserted in said cylindrical hole to widen an interval between at least two of said teeth of said bore spline, said at least two teeth of said bore spline being located in a vicinity of said thin wall portion, such that at least one of said at least two teeth of said bore spline is pressed against at least one associated tooth of said teeth of said shaft spline and is restrained to restrict movement of said hub relative to said shaft, and
at least one tooth of at least one of said shaft spline and bore spline, said at least one tooth being located in a vicinity of said thin wall portion facing said lower end portion of said cylindrical hole in said hub, is provided with a cutout portion formed by cutting off said at least one tooth at a part thereof such that said cutout portion is located in a neighborhood of an end face of said hub located on a side opposite another end face of said hub located on a side of an end portion of said shaft.

2. A spline connection structure according to claim 1, wherein said shaft has machining relief grooves machined by a pinion cutter.

3. A spline connection structure according to claim 1, wherein said shaft spline has elevated profile portions machined by a hob.

4. A spline connection structure according to claim 1, wherein said cylindrical hole is arranged extending toward a central axis of said shaft.

5. A spline connection structure according to claim 4, wherein said hub is provided with two cylindrical holes formed therein such that said two cylindrical holes are arranged side by side in a longitudinal direction of said shaft, and is also provided with a parallel slot communicating to respective lower ends of said two cylindrical holes and arranged extending in parallel with the longitudinal direction of said shaft.

6. A spline connection structure according to claim 1, wherein said cylindrical hole is provided with an internal thread, and said pressing member is a clamping screw having an external thread screwed on said internal thread.
